(19) United States
(12) Patent Application Publication
(10) Pub. No.: US 2011/0262310 A1
(43) Pub. Date: Oct. 27, 2011

(54) MULTILAYER HOSE FOR CONVEYING AN AQUEOUS SOLUTION CONTAINING UREA

(75) Inventor: Franco Colosimo, San Mauro Torinese (IT)

(73) Assignee: DYTECH - DYNAMIC FLUID TECHNOLOGIES S.P.A., Torino (IT)

(21) Appl. No.: 12/865,036

(22) PCT Filed: Jan. 30, 2008
(86) PCT No.: PCT/IT2008/000059

§ 371 Date: Nov. 12, 2010

(51) Int. Cl. B01D 53/34; F16L 11/00

(52) U.S. Cl. 422/173; 422/168; 138/124

(57) ABSTRACT

A multilayer hose for conveying an aqueous solution containing urea including a conveying pipe of the fluid, a heating element and an insulating layer. The heating element is a tubular braid or mesh or net element in which at least one wire is formed by a conductive material and one strand is formed by thermoplastic material.

### TECHNICAL FIELD

The present invention relates to a multilayer hose, specifically for conveying an aqueous solution containing urea.

### BACKGROUND ART

In order to comply with the new anti-pollution standards, which impose more restrictive exhaust gas emission limits with respect to the current ones, the use of the so-called SCR (Selective Catalytic Reduction) exhaust gas purification system is known. Such a system is adopted, specifically, for reducing the emission of nitrogen oxides into the atmosphere.

Preferably, the SCR system is used in commercial and industrial vehicles.

The SCR system consists in injecting an aqueous solution containing urea or an equivalent product capable of reacting with the nitrogen oxides at the catalyzer inlet by means of compressed air. Generally, an aqueous solution containing 32.5% of urea, for example the solution commonly marketed under the name AdBlue, is preferred. The catalyzer is arranged at the exhaust gas muffler and, inside it, the introduced urea reacts with the nitrogen oxides, also commonly designated as NO_{X}, eliminating them from the emissions into the atmosphere.

The aqueous solution containing urea is generally contained in a tank from where it is taken to be injected into the catalyzer, after being mixed with compressed air, according to times and methods defined by an electronic control unit which takes various parameters into account, such as for example temperature and humidity, engine operation and speed.

In use, the solution containing urea freezes when vehicles equipped with the SCR system are parked at temperatures lower than −12° C.: when the engine is started after parking, the hoses containing the solution containing urea are immediately heated by passage of electric current.

In practice, according to the most recent standards, reaching a temperature of −5° C. for the solution containing urea in less than 5 minutes after starting the engine is required, with the SCR system initially placed at a room temperature of −35° C.

Specifically, the hoses which allow to convey the aqueous solution containing urea must allow the passage of fluid in the working temperature range, that is between −40° C. and 120° C., must be flexible and must ensure that, under −40° C. conditions, the aqueous solution containing urea does not freeze in any part under all flow rate conditions, that is between 0 and 5.5 L/h.

Electrically heated hoses and fittings are therefore generally used for heating the aqueous solution containing urea.

For example, it is known the use of heated hoses consisting of TEFLON® pipes, with an electric resistor externally spiralled on the pipe, held onto the pipe by a polyethylene heat-shrink sheath which also serves the function of electric insulation, and is further covered by a corrugated polyamide tube.

Such a solution however does not allow to obtain a sufficiently rapid defrosting of the aqueous solution to comply with the aforementioned requirements due to the fact that the TEFLON® does not allow to conduct sufficient heat to warm the interior of the pipe. The TEFLON® pipes display further problems in their use in connection to couplings and are also very expensive.

Furthermore, in some applications tubes with a very small external diameter, specifically smaller than 10 mm, are needed.

None of the current tube configurations allow to obtain the defrosting of the solution containing urea in a short time unless they display diameters larger than mm, because a conductor wire having a diameter preferably from 0.2 to 0.5 mm, e.g. 0.3 mm, must be used in order to be able to conduct enough current to heat the frozen urea in the tube.

### DISCLOSURE OF INVENTION

It is thus the object of the present invention a hose for a SCR system which allows to avoid the above-described drawbacks and which therefore allows to rapidly defrost an aqueous solution containing urea, but which may advantageously have a total diameter smaller than 10 mm.

According to the present invention, this object is reached by a hose 1 made according to claim 1.

### BRIEF DESCRIPTION OF THE DRAWINGS

For a better understanding, the present invention is further described with reference to the accompanying figures in which:

FIG. 1 is a diagram of a SCR system;

FIG. 2 is a partial section view of a hose made according to the present invention; and

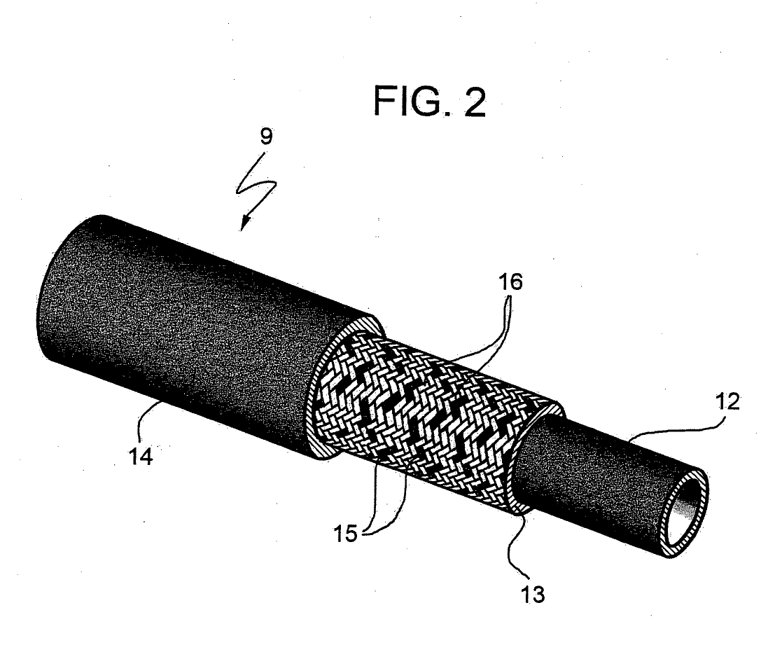

FIG. 3 is a graph comparing the defrosting time of a solution containing urea with a hose made according to the present invention and with hoses made according to the known art.

### BEST MODE FOR CARRYING OUT THE INVENTION

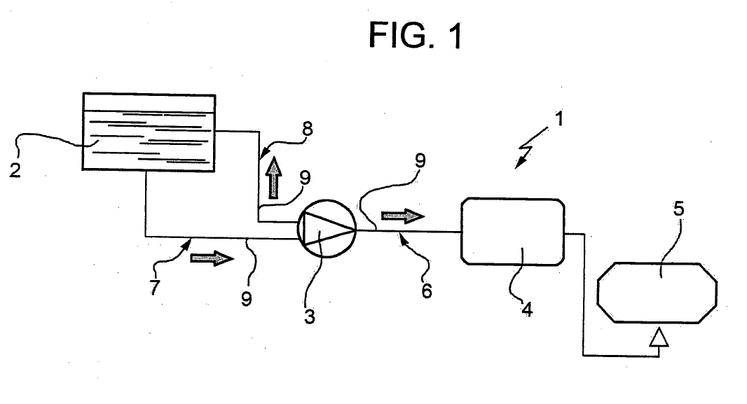

In FIG. 1, numeral 1 indicates a purification device or SCR system (diagrammatically shown) of a vehicle, comprising a tank 2 which may contain a solution containing 32.5% of urea, a pump module 3, and a dispensing module 4, which mixes the solution containing urea with compressed air in order to send it into a catalyzer 5 (diagrammatically shown) of the vehicle itself.

The pump module 3 is connected to the dispensing module 4 via a delivery line 6, and to the tank 2 via a suction line 7 and a recirculation line 8. The lines 6-8 comprise corresponding hoses 9, which are heatable by electric current and connected to the other components in the system 1 by means of fittings.

Preferably, the hose 9 comprises at least:
a fluid conveying pipe 12;
a heating element 13; and
an insulating layer 14.

Preferably, the hose 9 of the present invention is thus used for conveying an aqueous solution containing urea in a SCR system.

Specifically, the conveying pipe 12 is made of a preferably hydrolysis-resistant thermoplastic material.

More preferably, the conveying pipe 12 is formed by either homopolyamide or copolyamide, and even more preferably by polyamide 12.

Preferably, the polyamides used have a high hydrolysis resistance and a high resistance to low temperatures.

For example, it may be formed by polyamide 12 Arkema M-AESN NOIR P110TL, or alternatively Arkema M-AESN NOIR P123TL.

Preferably, the conveying pipe 12 displays an internal diameter between 2 and 6 mm, and even more preferably of 3 mm.

The heating element 13 consists of a tubular braid or mesh element 13 and is wrapped around the conveying pipe 12 so as to cover it entirely.

The braid element 13 is advantageously formed by braiding a plurality of plastic material strands or plastic strands 16 with at least one conductive material wire or conductive wires 15, preferably formed by metal material. The plastic material strands are more preferably formed by polyamide, but may alternatively be formed by polyester.

For example, 4 or 5 plastic strands may be used for each conductive wire and the used braid element may comprise 4 metal wires.

The geometries and the dimensions of the metal wires depend on the features required by the specific use and moreover depend on the dimensions of the components of the hose as a whole.

For example, metal wires formed by a NiCr 8020 alloy with a power of W=10-18 W/m with a current of 12 V may be used. Alternatively, the metal wires may be entirely formed by nickel.

The metal wires may be braided with polyester strands in a braid, for example of total diameter of 0.3 mm.

Alternatively, the conductive wires 15 may be arranged only in the weave or in the warp of the braid. Such an embodiment is particularly advantageous because it prevents the wires from crossing and short-circuiting. Specifically, such a solution allows to make the presence of an external wire for closing the circuit unnecessary, e.g. in the case in which a pair of wires is present, one for the positive pole and the other for the negative pole.

Alternatively, the braid element 13 may be entirely formed by conductive wires 15, preferably by metal material.

For example, the braid element 13 may consist of 2, 4 or 8 conductive wires.

In order to ensure the correct operation, the heating element 13 is generally coated by an insulating element 14.

Preferably, the insulating element 14 consists of a co-extruded layer 14 and preferably displays a thickness between 0.75 and 2.5 mm, e.g. of 1.5 mm.

The insulating element 14 is preferably formed by thermoplastic elastomer.

Specifically, the thermoplastic elastomer is also known with the acronym TPE. “Thermoplastic elastomer” means a polymeric material which behaves as an elastomer, but when heated can be processed like a thermoplastic.

Preferably, it is a thermoplastic elastomer of SUNPRENE® or SANTOPRENE® family.

Preferably, a thermoplastic elastomer with a polyolefin matrix base in which a dynamically crosslinked elastomeric phase is intimately dispersed is used.

More preferably, the polyolefin matrix is a polypropylene and the elastomeric phase is EPDM.

Alternatively, a thermoplastic elastomer formed by a thermoplastic/elastomer alternating block copolymer may be used.

For example, it is advantageous to use a thermoplastic elastomer with PBT-based thermoplastic and polyester glycol-based elastomer alternating block copolymer.

Alternatively, the insulating element 14 may be formed by polyurethane. More preferably, it is formed by open or closed cell polyurethane foam. More preferably, it is formed by closed cell polyurethane foam.

A hose 9 manufactured according to the above-described structure has an external diameter which may be of even only 8 mm and, at the same time, is capable of reaching the objective of defrosting the aqueous solution containing urea in less time than the known hoses, even less than 5 minutes.

The braid element 13 is electrically connected by means of a first clamp which connects the conductive wires to a first end and a second clamp 20 applied to a connector.

According to a preferred embodiment, each clamp comes into direct contact with the braid element 13, and specifically the conductive material wires, so as to define an electric connection with the latter.

Advantageously, the clamp fully surrounds the corresponding end portion of the braid element 13 and comprises a first and a second end portions which are rigidly connected, e.g. which mate and are subsequently ‘S’ folded to obtain a compact configuration in a radial direction.

It is apparent that many changes can be made to the hose described and illustrated herein, specifically to the percentage ratio of the chemical components forming the various layers and to the relative thicknesses of the layers, as well as to the number of layers themselves, without therefore departing from the scope of protection of the present invention. For example, further external reinforcement layers, or layers which improve the chemical resistance features, or barrier layers may be included.

Moreover, it is apparent that although specific reference is made to the conveying of an aqueous solution containing urea, a hose made according to the present invention may be advantageously used in all systems in which the fluid conveyed by the hose needs to be heated.

In the foregoing description, the advantages of a hose made according to the present invention are apparent; specifically by means of such a hose, it is possible to heat a liquid in less time than with the known hoses and, at the same time, to have a sufficiently flexible hose with a smaller diameter than the known hoses at a limited cost.

The invention will now be described by means of non-limiting examples.

### Example 1

Table 1 shows an example of a hose made according to the present invention, while tables 2 and 3 show examples of comparative compositions of hoses.

The examples are carried out with conveying pipes with an equal diameter of 3×5 mm.

TABLE 1

| Inventive example | |
|---|---|
| Conveying pipe 2 | Grilamid L25A H - EMS - PA12 |
| Heating element 3 | Braid with 4 wires or main |
| | conductors NiCr8020 wrapped with |
| | polyester strands to form a |
| | 0.3 mm braid. |
| Insulating element | Santoprene |

TABLE 2

| Comparative example 1 | |
|---|---|
| Conveying pipe | Grilamid L25A H - EMS - PA12 |
| Heating element | Bipolar NiCr8020 wire, 6.3 O, |
| | TEFLON ® insulated |
| Sealing element | Polyethylene heat-shrink sheath |
| Anti-abrasive layer | Corrugated tube |

TABLE 3

| Comparative example 2 | |
|---|---|
| Conveying pipe | VESTAMID LX9013 Degussa - PA12 |
| Heating element | Bipolar NiCr8020 wire, 6.3 O, |
| | TEFLON ® insulated |
| Sealing element | Polyethylene heat-shrink sheath |
| Anti-abrasive layer | Corrugated tube |

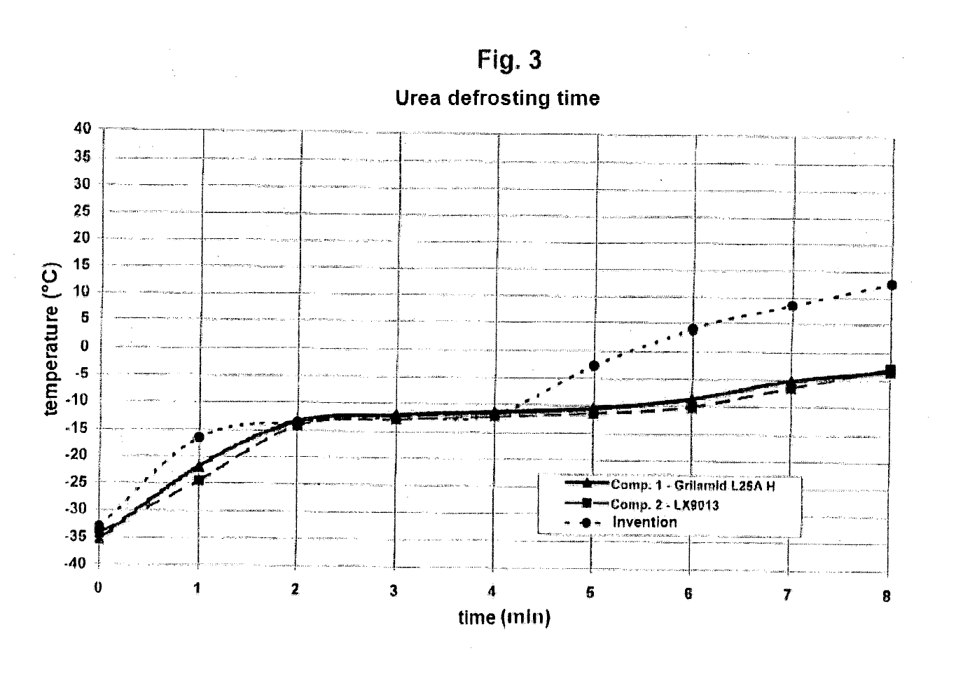

Graph 1 in FIG. 3 shows the temperature value trend in time of an aqueous solution containing 32.5% of urea contained in the hose according to the present invention, the composition of which was described above in table 1, and in the comparative hoses the composition of which was shown in tables 2 and 3.

Such a temperature is measured by introducing the hoses, inside which the aqueous solution containing urea is introduced, into a sealed climatic cell where the temperature of −35° C. is stabilized. In such a manner, the solution contained therein is frozen taking it also to a temperature of −35° C.

After stabilizing the temperature, the electric connections of the electric resistor wrapped on the conveying pipe are connected to an electric power supply at a voltage of 24V, and thus a current of 3.8 A is circulated.

A series of thermocouples placed inside the hose allows to determine the temperature of the aqueous solution.

It is apparent that the use of a hose made according to the present invention allows to take the temperature of the aqueous solution containing urea to −5° C. in 5 minutes, while with the known hoses such a limit is not reached.

1. A hose for conveying urea comprising a fluid conveying pipe, a heating element and an insulating element, characterized in that said heating element consists of a tubular braid element comprising at least one conductive material wire.

2. The hose according to claim 1, wherein said braid element comprises at least one pair of said conductive material wires.

3. The hose according to claim 2, wherein said braid element comprises wires either only in the weave or only in the warp.

4. The hose according to claim 1, wherein said braid element further comprises at least one thermoplastic material strand.

5. The hose according to claim 1, wherein said insulating element comprises a thermoplastic elastomer.

6. The hose according to claim 5, wherein said thermoplastic elastomer comprises a polyolefin matrix base in which an elastomeric phase is intimately dispersed.

7. The hose according to claim 6, wherein said polyolefin matrix base comprises polypropylene.

8. The hose according to claim 6, wherein said elastomeric phase is EPDM.

9. The hose according to claim 1, wherein said conductive wires comprise Ni.

10. The hose according to claim 1, wherein said thermoplastic material strands are formed by homopolyester or copolyester or by homopolyamide or copolyamide.

11. The hose according to claim 10, wherein said thermoplastic material strands comprise polyester.

12. The hose according to claim 1, wherein said conveying pipe comprises homopolyamide or copolyamide.

13. The hose according to claim 12, wherein said conveying pipe is formed by polyamide 12.

14. A vehicle exhaust gas purification device, comprising a tank containing a solution containing urea, a pump module, a catalyzer and at least one hose for conveying said solution containing urea, said hose comprising a fluid conveying pipe, a heating element and an insulating element, characterized in that said heating element consists of a tubular braid element comprising at least one conductive material wire.

15. A vehicle exhaust gas purification device, comprising a tank containing a solution containing urea, a pump module, a catalyzer and at least one hose according to claim 1.
